(19) United States
(12) Patent Application Publication
(10) Pub. No.: US 2021/0106498 A1
(43) Pub. Date: Apr. 15, 2021

(54) Plastic Jacket for Vial Labeling Systems

(71) Applicant: Allogene Therapeutics, Inc., San Francisco, CA (US)

(72) Inventors: Stephen Flores, San Bruno, CA (US); Patricia M. Kessler, San Francisco, CA (US)

(21) Appl. No.: 17/064,241

(22) Filed: Oct. 6, 2020

Related U.S. Application Data
(60) Provisional application No. 62/913,859, filed on Oct. 11, 2019.

(51) Int. Cl. A61J 1/16; A61J 1/14; B65D 23/00; B65D 23/08

(52) U.S. Cl. CPC A61J 1/165; A61J 1/1468; A61J 2205/30; B65D 23/0857; B65D 23/005

(57) ABSTRACT

A vial jacket configured to receive a label. The vial jacket includes a plastic material having a cryogenic operating temperature range, a hinge formed in the plastic material, a locking mechanism, and an opening formed in the plastic material. The plastic material is dimensioned to surround at least a portion of a vial. The hinge defines a first half shell having a first edge and a second half shell having a second edge. The locking mechanism is configured to secure the first edge of the first half shell to the second edge of the second half shell. The opening has an axial length and a transverse length.

### CROSS REFERENCE TO RELATED APPLICATIONS

This application claims the benefit of priority to U.S. Provisional Patent Application No. 62/913,859, filed Oct. 11, 2019, the entire contents of which are owned by the assignee of the instant application and incorporated herein by reference in its entirety.

### FIELD OF THE INVENTION

The present invention relates generally to systems and methods for labeling vial systems, including systems and methods for labeling vial systems at cryogenic temperatures.

### BACKGROUND OF THE INVENTION

Maintaining vials at low temperatures during storage and transportation is often required to preserve and maintain the integrity of the product contained in the vials. For example, vials containing certain medical or chemical products require cryogenic storage and shipping temperatures. A cryogenic temperature range typically includes temperatures approximately between −190° C. and 0° C. Additionally, vials often require labels that satisfy labeling requirements that may be country specific. For example, if a vial contains a medical or chemical product, the vial label is required to identify the name of the product as well as the expiry date, among other requirements. Vial labels may also need to identify the name of a patient if the vials contain a medial product that is patient-specific. Also, it is often required for the label to not cover the entire surface of the vial in order to facilitate visual inspection of the contents inside the vial.

However, traditional labeling techniques often require vials to be at room temperature during the application process. This is undesirable because cryogenically stored products are temperature sensitive and should not be thawed, labeled, and refrozen. Additionally, it is not optimal to label vials at room temperature before freezing because it requires bulk labeling of vials before knowing to what markets and/or countries the vials will be shipped. Furthermore, vial labels often separate from the surface of the vials when stored at cryogenic temperatures due to a loss of adhering properties of the labels at low temperatures. Additionally, difficulties have been encountered when using traditional labeling techniques to apply labels to vials at cryogenic temperatures due to the buildup of frost on the surface of the vials in addition to the loss of adhering properties of labels at low temperatures. Consequently, there is a need for a better solution for labeling vials stored at cryogenic temperatures such that the labeling can be applied at cryogenic temperatures and the labels remain adhered throughout storage and transport.

### SUMMARY OF THE INVENTION

Accordingly, an object of the invention is to provide users with a vial jacket that can receive a label and maintain the label adhered at a cryogenic temperature range. It is an object of the invention to provide users with systems and methods to permit the user to securely surround a vial with the vial jacket during storage and transportation. It is an object of the invention to provide users with systems and methods to permit the user to inspect the contents of the vial through a viewing window in the vial jacket.

In some aspects, a vial jacket configured to receive a label includes a plastic material, a hinge formed in the plastic material, a locking mechanism, and an opening formed in the plastic material. The plastic material has a cryogenic operating temperature range and is dimensioned to surround at least a portion of a vial. The hinge defines a first half shell having a first edge and a second half shell having a second edge. The locking mechanism is configured to secure the first edge of the first half shell to the second edge of the second half shell. The opening has an axial length and a transverse length.

In some embodiments, the cryogenic operating temperature range comprises a range of about −150° C. to about 0° C. In some embodiments, the cryogenic operating temperature range comprises a range of about −190° C. to about 0° C. In some embodiments, the cryogenic operating temperature range comprises a range of about −190° C. to about −135° C. In some embodiments, the cryogenic operating temperature range comprises a range of about −150° C. to about −135° C. In some embodiments, the cryogenic operating temperature range comprises about one of the group consisting of −190° C., −180° C., −135° C., −80° C., and 0° C.

In some embodiments, the hinge is formed by a thinning of the plastic material. In some embodiments, the plastic material comprises at least one of HDPE, polypropylene, or other suitable plastic.

In some embodiments, the locking mechanism secures the vial jacket to the vial. In some embodiments, the locking mechanism is configured to snap fit the first edge of the first half shell to the second edge of the second half shell.

In some embodiments, the axial length of the opening is different than the transverse length of the opening. In some embodiments, the axial length of the opening is greater than the transverse length of the opening. In some embodiments, the transverse length of the opening is greater than the axial length of the opening. In some embodiments, the opening is proximate to at least one of the first edge of the first half shell or the second edge of the second half shell.

In some aspects, a vial assembly includes a vial and a vial jacket configured to receive a label. The vial jacket includes a plastic material, a hinge formed in the plastic material, a locking mechanism, and an opening formed in the plastic material. The plastic material has a cryogenic operating temperature range and is dimensioned to surround at least a portion of the vial. The hinge defines a first half shell having a first edge and a second half shell having a second edge. The locking mechanism is configured to secure the first edge of the first half shell to the second edge of the second half shell. The opening has an axial length and a transverse length.

In some embodiments, the cryogenic operating temperature range comprises a range of about −150° C. to about 0° C. In some embodiments, the cryogenic operating temperature range comprises a range of about −190° C. to about 0° C. In some embodiments, the cryogenic operating temperature range comprises a range of about −190° C. to about −135° C. In some embodiments, the cryogenic operating temperature range comprises a range of about −150° C. to about −135° C. In some embodiments, the cryogenic operating temperature range comprises about one of the group consisting of −190° C., −180° C., −135° C., −80° C., and 0° C.

In some embodiments, the hinge is formed by a thinning of the plastic material. In some embodiments, the plastic material comprises at least one of HDPE, polypropylene, or other suitable plastic.

In some embodiments, the locking mechanism secures the vial jacket to the vial. In some embodiments, the locking mechanism is configured to snap fit the first edge of the first half shell to the second edge of the second half shell.

In some embodiments, the axial length of the opening is different than the transverse length of the opening. In some embodiments, the axial length of the opening is greater than the transverse length of the opening. In some embodiments, the transverse length of the opening is greater than the axial length of the opening. In some embodiments, the opening is proximate to at least one of the first edge of the first half shell or the second edge of the second half shell.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A is an isometric view of an exemplary vial assembly according to an embodiment of the invention.

FIG. 1B is an isometric view of an exemplary vial assembly according to an embodiment of the invention.

FIG. 2A is an isometric view of an exemplary vial jacket with a clasping locking mechanism according to an embodiment of the invention.

FIG. 2B is an isometric view of the exemplary vial jacket shown in FIG. 2A in an open configuration according to an embodiment of the invention.

FIG. 3 is an isometric view of an exemplary vial jacket with a ratchet locking mechanism in an open configuration according to an embodiment of the invention.

FIG. 4 is an isometric view of an exemplary vial jacket with a sheath locking mechanism in an open configuration according to an embodiment of the invention.

FIG. 5A is an isometric view of an exemplary vial assembly according to an embodiment of the invention.

FIG. 5B is an isometric view of the exemplary vial assembly shown in FIG. 5A in a closed configuration according to an embodiment of the invention.

FIG. 5C is an isometric view of the exemplary vial assembly shown in FIG. 5A according to an embodiment of the invention.

FIG. 5D is an isometric view of the exemplary vial assembly shown in FIG. 5A according to an embodiment of the invention.

FIG. 6A is an isometric view of an exemplary vial assembly in a closed configuration according to an embodiment of the invention.

FIG. 6B is an isometric view of the exemplary vial assembly shown in FIG. 6A according to an embodiment of the invention.

FIG. 6C is an isometric view of the exemplary vial assembly shown in FIG. 6A according to an embodiment of the invention.

FIG. 7A is an isometric view of an exemplary vial assembly in a closed configuration according to an embodiment of the invention.

FIG. 7B is an isometric view of the exemplary vial assembly shown in FIG. 7A according to an embodiment of the invention.

FIG. 7C is an isometric view of the exemplary vial assembly shown in FIG. 7A according to an embodiment of the invention.

FIG. 8A is an isometric view of a female locking component of the exemplary vial assembly shown FIG. 7A according to an embodiment of the invention.

FIG. 8B is an isometric view of a male locking component of the exemplary vial assembly shown in FIG. 7A according to an embodiment of the invention.

### DETAILED DESCRIPTION OF THE INVENTION

In some aspects, the systems and methods described herein can include a vial jacket that can receive a label and maintain the label adhered at a cryogenic temperature range. The systems and methods described herein can permit the user to securely surround a vial with the vial jacket during storage and transportation. The systems and methods described herein can permit the user to inspect the contents of the vial through an opening in the vial jacket.

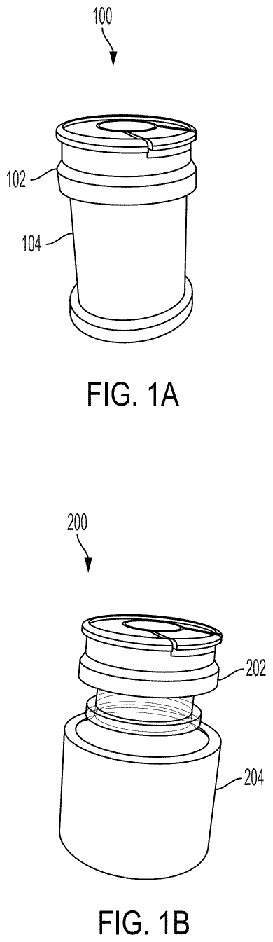

Referring to FIGS. 1A and 1B, example vial assemblies 100 and 200 include a small vial 102 and a large vial 202, respectively. Vial assembly 100 includes a vial jacket 104 dimensioned to surround at least a portion of small vial 102. Vial assembly 200 includes a vial jacket 204 dimensioned to surround at least a portion of large vial 202. Vials 102 and 202 can range in size from 1 mL up to 50 mL. For example, in some embodiments, the small vial 102 can be 2 mL and the large vial 202 can be 6 mL. The vial jackets 104 and 204 can comprise a plastic material and can be produced using injection molding techniques or 3D printing techniques. In some embodiments, vial jackets 104 and 204 are produced from an injection mold using polypropylene, high-density polyethylene (HDPE), or another suitable plastic for injection molding or 3D printing.

The surfaces of the vial jackets 104 and 204 may be suitable for receiving a label. The label may comprise information identifying a product inside of the vials 102 or 202, and any additional information related to the product. In some embodiments, the label is pressure-sensitive and adhesive. In some embodiments, the label is produced from a suitable plastic face stock and a cryo-stable adhesive attached to a release liner. In other embodiments, the label is produced from a suitable paper face stock and a cryo-stable adhesive attached to a release liner. In some embodiments, the label is a plastic label molded in place with the jacket, referred to as an in-mold label, forming a one-piece label/jacket component. The cryo-stable adhesive allows the label to adhere to the surface of the vial jackets 104 and 204 at a temperature range approximately between −190° C. and 0° C., and up to room temperature conditions. During the application process, the label is applied to the vial jacket and cured in order to secure the label onto the vial jacket in preparation for storage at frozen temperatures.

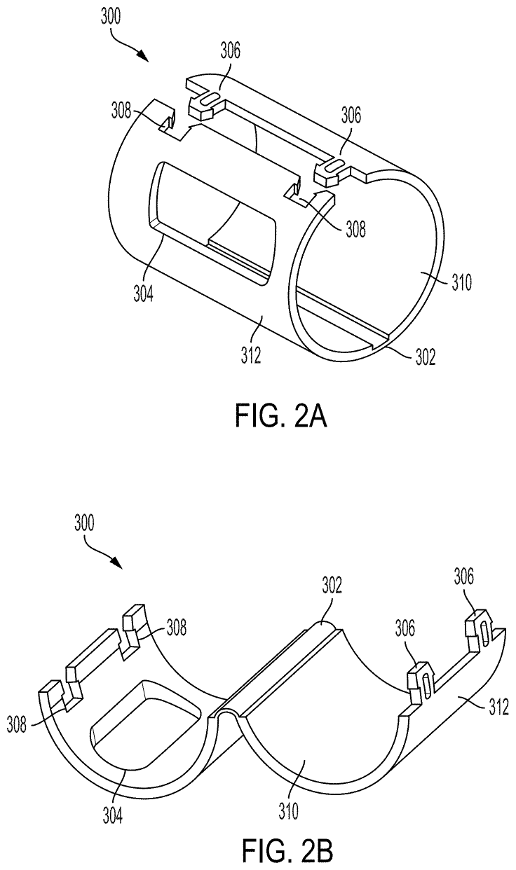

The vial jacket embodiments described herein comprise various features and mechanisms that facilitate use with vials and vial assemblies. For example, referring to FIGS. 2A and 2B, an example plastic vial jacket 300 includes a hinge 302 and an opening 304. The hinge 302 defines a first half shell and a second half shell of the vial jacket 300. Each of the half shells includes edges that join when the vial jacket 300 is in a closed configuration. In some embodiments, the hinge 302 is formed by a thinning of the plastic material of the vial jacket 300. The hinge 302 allows for easier injection mold processing, allows the vial jacket 300 to be stored and shipped in a nesting position, and allows for easy manipulation during attachment to a vial. The opening 304 has an axial length and a transverse length and allows a user to inspect the contents inside the vial. In some embodiments, the axial length and the transverse length of the opening 304 are different. For example, in some embodiments, the axial length of the opening 304 is greater than the transverse length of the opening 304. In other embodiments, the transverse length of the opening 304 is greater than the axial length of the opening 304. In some embodiments, the axial length and the transverse length of the opening 304 are the same. For example, in some embodiments, the opening may be a square shape.

FIG. 2B illustrates the plastic vial jacket 300 in an open configuration. The plastic vial jacket 300 includes an inner surface 310 and an outer surface 312. The thickness of the plastic vial jacket 300 is defined by the inner surface 310 and the outer surface 312. When the plastic vial jacket 300 is in a closed configuration around a vial, the inner surface 310 may be in contact with the outer surface of the vial. The outer surface 312 may be configured to receive a cryo-stable label. In some embodiments, the outer surface 312 of the plastic vial jacket 300 is treated prior to labeling in order to improve the subsequent adhesion of the label. In some embodiments, the opening 304 is proximate to an edge of one of the half shells of the plastic vial jacket 300. This allows for the label to occupy a large portion of the outer surface 312 of the plastic vial jacket 300.

The plastic vial jacket 300 includes a clasping locking mechanism that is configured to secure a first edge of the first half shell to a second edge of the second half shell. The clasping locking mechanism includes one or more male components 306 at the first edge of the first half shell and one or more female components 308 at the second edge of the second half shell. The embodiment shown in FIGS. 2A and 2B comprise two male components 306 and two corresponding female components 308. However, in some embodiments, the plastic vial jacket 300 may comprise one male component 306 and one corresponding female component 308. In other embodiments, the plastic vial jacket 300 may comprise three or more male components 306 and three or more corresponding female components 308. In a closed configuration, at least one male component 306 is inserted and secured into at least one female component 308 such that the first edge of the first half shell is secured to the second edge of the second half shell. The male component 306 includes wings that can be coupled to indentations included in the female component 308. In some embodiments, the edges of the half shells of the plastic vial jacket 300 are snap fit in the closed configured.

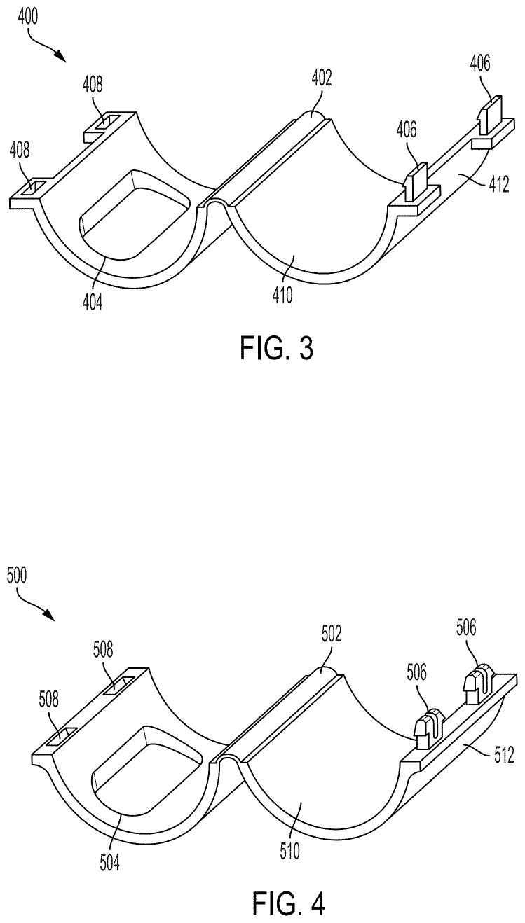

FIGS. 3 and 4 illustrate example vial jackets including alternative locking mechanisms. For example, referring to FIG. 3, an example vial jacket 400 includes a ratchet locking mechanism. Similar to vial jacket 300 described in relation for FIGS. 2A and 2B, vial jacket 400 includes a hinge 402, an opening 404, an inner surface 410, and an outer surface 412. The ratchet locking mechanism is configured to secure a first edge of a first half shell of the vial jacket 400 to a second edge of a second half shell of the vial jacket 400. The ratchet locking mechanism includes one or more male components 406 at the first edge of the first half shell and one or more female components 408 at the second edge of the second half shell. In a closed configuration, at least one male component 406 is inserted and secured into at least one female component 408 such that the first edge of the first half shell is secured to the second edge of the second half shell. The male component 406 includes a wing that can be coupled to the female component 408.

Referring to FIG. 4, an example vial jacket 500 includes a sheath locking mechanism. Similar to vial jacket 300 described in relation to FIGS. 2A and 2B, vial jacket 500 includes a hinge 502, an opening 504, an inner surface 510, and an outer surface 512. The sheath locking mechanism is configured to secure a first edge of a first half shell of the vial jacket 500 to a second edge of a second half shell of the vial jacket 500. The sheath locking mechanism includes one or more male components 506 at the first edge of the first half shell and one or more female components 508 at the second edge of the second half shell. In a closed configuration, at least one male component 506 is inserted and secured into at least one female component 508 such that the first edge of the first half shell is secured to the second edge of the second half shell. The male component 506 includes wings that can be coupled to the female component 508.

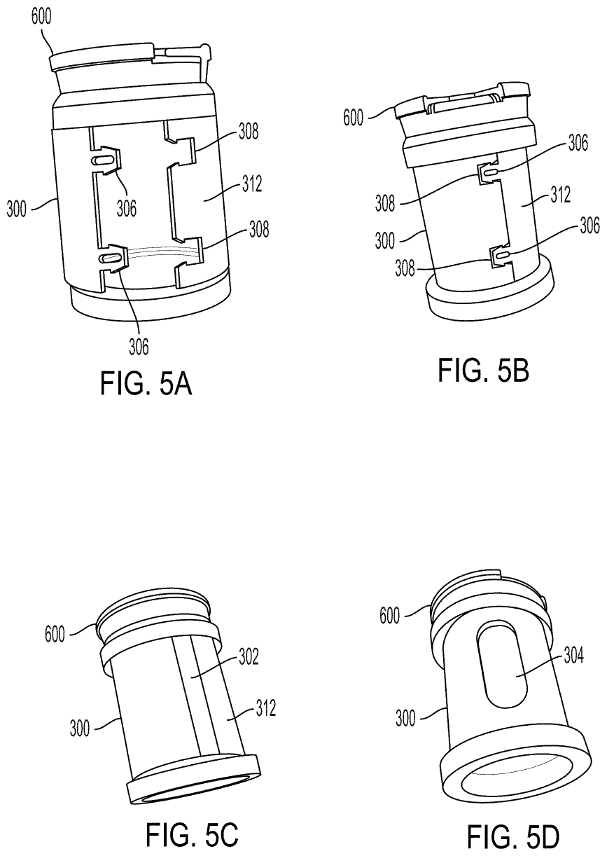

Referring to FIGS. 5A through 5D, an example vial 600 is surrounded by a plastic vial jacket 300. Vial 600 can range in size from 1 mL up to 50 mL. For example, in some embodiments, vial 600 is a 2 mL vial. As described in relation to FIGS. 2A and 2B, plastic vial jacket 300 includes a hinge 302, an opening 304, an outer surface 312, and a locking mechanism comprising at least one male component 306 and at least one female component 308. The process of securing the plastic vial jacket 300 around vial 600 begins with the plastic vial jacket 300 in an open configuration. As shown in FIG. 5A, the plastic vial jacket 300 surrounds vial 600. As shown in FIG. 5B, one or more male components 306 are secured to corresponding female components 308, securing the plastic vial jacket 300 to the vial 600. In some embodiments, the locking mechanism comprises a clasping locking mechanism as described in relation to FIGS. 2A and 2B, a ratchet locking mechanism as described in relation to FIG. 3, or a sheath locking mechanism as described in relation to FIG. 4.

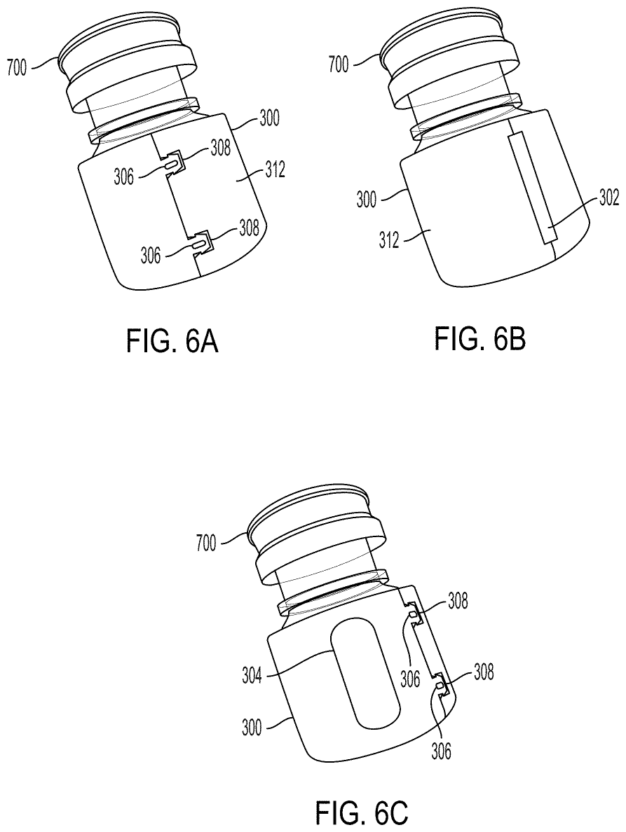

Referring to FIGS. 6A through 6C, an example vial 700 is surrounded by a plastic vial jacket 300. Vial 700 can range in size from 1 mL up to 50 mL. For example, in some embodiments, vial 700 is a 6 mL vial. As described in relation to FIGS. 2A and 2B, plastic vial jacket 300 includes a hinge 302, an opening 304, an outer surface 312, and a locking mechanism comprising at least one male component 306 and at least one female component 308. The process of securing the plastic vial jacket 300 around vial 700 begins with the plastic vial jacket 300 in an open configuration. As shown in FIG. 6A, the plastic vial jacket 300 surrounds vial 700 and one or more male components 306 are secured to corresponding female components 308, securing the plastic vial jacket 300 to the vial 700. In some embodiments, the locking mechanism comprises a clasping locking mechanism as described in relation to FIGS. 2A and 2B, a ratchet locking mechanism as described in relation to FIG. 3, or a sheath locking mechanism as described in relation to FIG. 4.

In an illustrative embodiment, a vial jacket 300 configured to receive a label includes a plastic material, a hinge 302 formed in the plastic material, a locking mechanism, and an opening 304 formed in the plastic material. The plastic material has a cryogenic operating temperature range and is dimensioned to surround at least a portion of a vial 600 (or 700). The hinge 302 defines a first half shell having a first edge and a second half shell having a second edge. The locking mechanism is configured to secure the first edge of the first half shell to the second edge of the second half shell. The opening 304 has an axial length and a transverse length.

In some embodiments, the cryogenic operating temperature range comprises a range of about −150° C. to about 0° C. In some embodiments, the cryogenic operating temperature range comprises a range of about −190° C. to about 0° C. In some embodiments, the cryogenic operating temperature range comprises a range of about −190° C. to about −135° C. In some embodiments, the cryogenic operating temperature range comprises a range of about −150° C. to about −135° C. In some embodiments, the cryogenic operating temperature range comprises about one of the group consisting of −190° C., −180° C., −135° C., −80° C., and 0° C. In some embodiments, the hinge 302 is formed by a thinning of the plastic material. In some embodiments, the plastic material comprises at least one of HDPE, polypropylene, or other suitable plastic.

In some embodiments, the locking mechanism secures the vial jacket 300 to the vial 600. In some embodiments, the locking mechanism is configured to snap fit the first edge of the first half shell to the second edge of the second half shell. In some embodiments, the axial length of the opening 304 is different than the transverse length of the opening 304. In some embodiments, the axial length of the opening 304 is greater than the transverse length of the opening 304. In some embodiments, the transverse length of the opening 304 is greater than the axial length of the opening 304. In some embodiments, the opening 304 is proximate to at least one of the first edge of the first half shell or the second edge of the second half shell.

In another illustrative embodiment, a vial assembly includes a vial 600 (or 700) and a vial jacket 300 configured to receive a label. The vial jacket includes a plastic material, a hinge 302 formed in the plastic material, a locking mechanism, and an opening 304 formed in the plastic material. The plastic material has a cryogenic operating temperature range and is dimensioned to surround at least a portion of the vial 600 (or 700). The hinge 302 defines a first half shell having a first edge and a second half shell having a second edge. The locking mechanism is configured to secure the first edge of the first half shell to the second edge of the second half shell. The opening 304 has an axial length and a transverse length.

In some embodiments, the cryogenic operating temperature range comprises a range of about −150° C. to about 0° C. In some embodiments, the cryogenic operating temperature range comprises a range of about −190° C. to about 0° C. In some embodiments, the cryogenic operating temperature range comprises a range of about −190° C. to about −135° C. In some embodiments, the cryogenic operating temperature range comprises a range of about −150° C. to about −135° C. In some embodiments, the cryogenic operating temperature range comprises about one of the group consisting of −190° C., −180° C., −135° C., −80° C., and 0° C. In some embodiments, the hinge 302 is formed by a thinning of the plastic material. In some embodiments, the plastic material comprises at least one of HDPE, polypropylene, or other suitable plastic.

In some embodiments, the locking mechanism secures the vial jacket 300 to the vial 600 (or 700). In some embodiments, the locking mechanism is configured to snap fit the first edge of the first half shell to the second edge of the second half shell. In some embodiments, the axial length of the opening 304 is different than the transverse length of the opening 304. In some embodiments, the axial length of the opening 304 is greater than the transverse length of the opening 304. In some embodiments, the transverse length of the opening 304 is greater than the axial length of the opening 304. In some embodiments, the opening 304 is proximate to at least one of the first edge of the first half shell or the second edge of the second half shell.

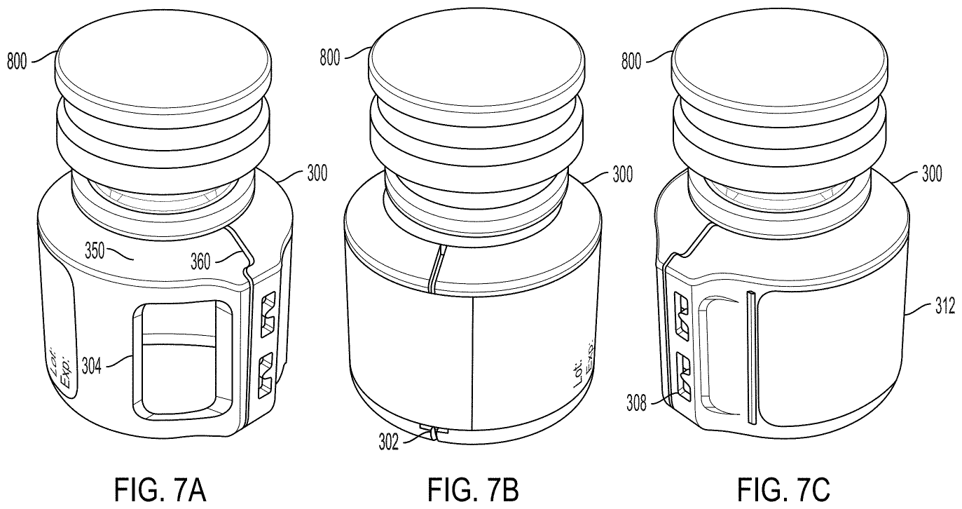

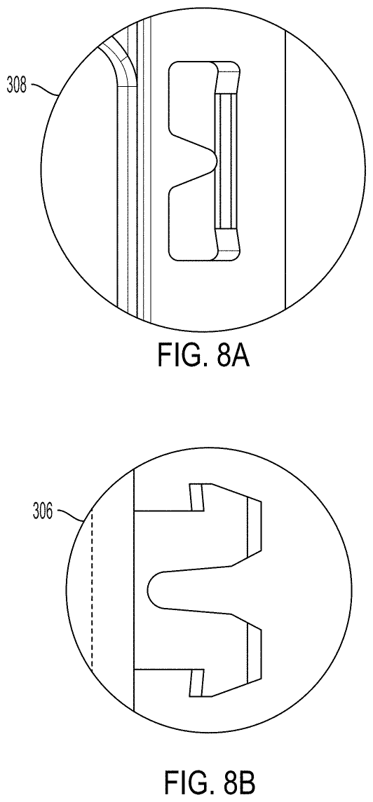

Referring to FIGS. 7A through 7C, an example vial 800 is surrounded by a plastic vial jacket 300. Vial 800 can range in size from 1 mL up to 50 mL. For example, in some embodiments, vial 800 is a 6 mL vial. As described in relation to FIGS. 2A and 2B, plastic vial jacket 300 includes a hinge 302, an opening 304, an outer surface 312, and a locking mechanism comprising at least one male component 306 and at least one female component 308. As shown in FIGS. 7A through 7C, plastic vial jacket 300 includes a raised shoulder 350 and a narrow seam 360 that allows for a more secure fit around vial 800. Additionally, as shown in FIGS. 7A through 7C, the locking mechanism can be raised in order to enable an easier grip and close. As shown in FIGS. 8A and 8B, in some embodiments, the female component 308 can be enlarged in order to allow for larger male components 306, and the male component 306 can include an angled wings to better secure with the female component 308.

As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

One skilled in the art will realize the invention can be embodied in other specific forms without departing from the spirit or essential characteristics thereof. The foregoing embodiments are therefore to be considered in all respects illustrative rather than limiting of the invention described herein. It will be appreciated that the illustrated embodiments and those otherwise discussed herein are merely examples of the invention and that other embodiments, incorporating changes thereto, including combinations of the illustrated embodiments, fall within the scope of the invention.

What is claimed:

1. A vial jacket configured to receive a label, the vial jacket comprising:
a plastic material having a cryogenic operating temperature range, the plastic material dimensioned to surround at least a portion of a vial;
a hinge formed in the plastic material, the hinge defining a first half shell comprising a first edge and a second half shell comprising a second edge;
a locking mechanism configured to secure the first edge of the first half shell to the second edge of the second half shell; and
an opening formed in the plastic material having an axial length and a transverse length.

2. The vial jacket of claim 1, wherein the cryogenic operating temperature range comprises a range of about −150° C. to about 0° C.

3. The vial jacket of claim 1, wherein the cryogenic operating temperature range comprises a range of about −190° C. to about 0° C.

4. The vial jacket of claim 1, wherein the hinge is formed by a thinning of the plastic material.

5. The vial jacket of claim 1, wherein the plastic material comprises at least one of HDPE, polypropylene, or other suitable plastic.

6. The vial jacket of claim 1, wherein the locking mechanism secures the vial jacket to the vial.

7. The vial jacket of claim 1, wherein the locking mechanism is configured to snap fit the first edge of the first half shell to the second edge of the second half shell.

8. The vial jacket of claim 1, wherein the axial length of the opening is greater than the transverse length.

9. The vial jacket of claim 1, wherein the transverse length of the opening is greater than the axial length.

10. The vial jacket of claim 1, wherein the opening is proximate to at least one of the first edge of the first half shell or the second edge of the second half shell.

11. A vial assembly comprising a vial and a vial jacket configured to receive a label, the vial jacket comprising:
a plastic material having a cryogenic operating temperature range, the plastic material dimensioned to surround at least a portion of the vial;
a hinge formed in the plastic material, the hinge defining a first half shell comprising a first edge and a second half shell comprising a second edge;
a locking mechanism configured to secure the first edge of the first half shell to the second edge of the second half shell; and
an opening formed in the plastic material having an axial length and a transverse length.

12. The vial assembly of claim 11, wherein the cryogenic operating temperature range comprises a range of about −150° C. to about 0° C.

13. The vial assembly of claim 11, wherein the cryogenic operating temperature range comprises a range of about −190° C. to about 0° C.

14. The vial assembly of claim 11, wherein the hinge is formed by a thinning of the plastic material.

15. The vial assembly of claim 11, wherein the plastic material comprises at least one of HDPE, polypropylene, or other suitable plastic.

16. The vial assembly of claim 11, wherein the locking mechanism secures the vial jacket to the vial.

17. The vial assembly of claim 11, wherein the locking mechanism is configured to snap fit the first edge of the first half shell to the second edge of the second half shell.

18. The vial assembly of claim 11, wherein the axial length of the opening is greater than the transverse length.

19. The vial assembly of claim 11, wherein the transverse length of the opening is greater than the axial length.

20. The vial assembly of claim 11, wherein the opening is proximate to at least one of the first edge of the first half shell or the second edge of the second half shell.
